(19) United States
(12) Patent Application Publication
(10) Pub. No.: US 2002/0129464 A1
(43) Pub. Date: Sep. 19, 2002

(54) Door hinge safety cover

(76) Inventor: Andrea M. Davis, St. Charles, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 09/812,114

(22) Filed: Mar. 13, 2001

(51) Int. Cl. E05D 11/00

(52) U.S. Cl. 16/250

(57) ABSTRACT

A safety product for a door hinge that includes two mating knuckles and a hinge pin, where the safety product is a cover that prevents injury to children, people, or objects from striking the door hinge. The cover has a top end, and a pin head of the door hinge passes through the top end so as to secure the top end to the door hinge. The top end is deformable as to cover at least a portion of the top of the pin head. The cover has a body portion which extends generally the length of the knuckles and formed integrally with the top end. The body portion has a slit for accommodating the width of the flanges of the knuckles. The cover also includes a bottom end which covers the bottom of the hinge and fits into the bottom of the hinge to assist in securing the cover.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to safety products for preventing injury to children, particularly to a safety product to prevent children's injury on a door hinge.

Parents and others who live with and rear children spend a great deal of time, effort, and concern in protecting children from hurting themselves in a home. There is a myriad of products available for preventing injury to children. For instance, wall outlet covers are made to prevent children from sticking objects into the outlet, thereby preventing electrocution.

Early developmental children have trouble walking and often tumble into objects around homes and other places. Again, products are made for preventing injuring when a child loses its balance and falls. One example is corner attachments made for the corners of furniture. As many objects are in the proximity of a small child while it is walking, the concern is to prevent injury if the child's body or head should strike something while falling.

Another concern is making that product difficult for the child to remove. Young children explore their world through their mouth and hands. If something is easily pulled off, a child will discover this and repeatedly remove it. In addition, children will chew on things, particularly those which are freed from other objects.

One point of concern which the field of the art has yet to address is door hinges. Door hinges in a home or other place are typically fashioned from steel, or brass, or some other type of metal. A hinge is typically a pair of mating knuckles, one mounted in the door frame and one mounted in the door, joined and secured to each other with a pin driven in from the top. Each knuckle has a flange part, typically countersunk into the door frame, and a circular part which mates with a circular part of the other knuckle, countersunk in the door and protruding from the plane of the door and a wall to which the door frame is attached. By inserting the pin from the top, the motion of the door swinging minimizes the possibility that the pin will free itself as its own weight serves to retain the pin in the knuckles. It is easily recognized that the top edge of a metal hinge exposes a pin with a hard edge with a small curvature and often with a cylindrical shape producing a generally right angle. It is also commonly known that pins, over time, may rise from the knuckles a short distance thereby exposing the hard, sharp edge of a knuckle.

Accordingly, it is desirable to produce a safety product which minimizes an injury to a child who falls over and strikes the door hinge. Although the focus of this would be to protect children, this product would also protect other people or objects which may accidentally strike the protruding portion of the door hinge.

As a further use to this product, doors are often shipped with hinges already attached. Typically, these doors are surrounded by plastic sheeting or cardboard to prevent damage in transit. Additionally, the hinges themselves which protrude from the doors are often covered also. It will be appreciated that the present invention can be used to cover these door hinges while the doors with attached hinges are in transit.

### BRIEF SUMMARY OF THE INVENTION

The present invention resides in a door hinge safety cover. The cover protects objects or beings which may strike the door hinge, thereby preventing damage or injury. The cover is a soft material, such as rubber, which fits over and into the top and bottom of the hinge knuckles. In addition, the hinge pin fits into the top of the cover, preferably the cover being deformed to cover a portion of the top surface of the hinge pin.

### BRIEF DESCRIPTION OF THE SEVERAL VIEWS OF THE DRAWINGS

In the drawings, FIG. 1 is a perspective view of the door hinge safety cover of the present invention;

FIG. 2 is a front elevation view of the door hinge safety cover of the present invention with its ends opened;

FIG. 3. is a side elevation view of the door hinge safety cover of the present invention with its ends opened;

FIG. 4 is a top plan view of the door hinge safety cover of the present invention with its ends opened;

FIG. 5 is an exploded view of the door hinge safety cover of the present invention, a door hinge pin, and door hinge knuckles;

FIG. 6 is a partial cross-sectional view of the door hinge safety cover of the present invention as installed on a door hinge.

FIG. 7 is a partial cross-sectional view of an alternative embodiment of the door hinge safety cover of the present invention as installed on a door hinge.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention.

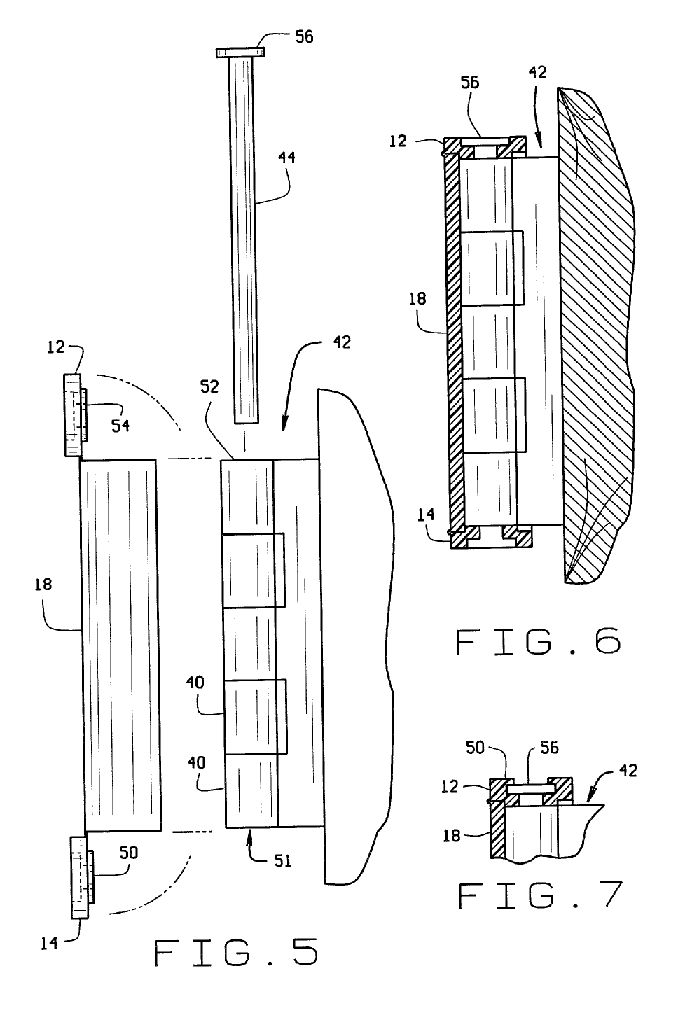

Referring initially to FIG. 1, a door hinge safety cover 10 of the present invention is depicted, herein referred to as cover 10. The cover is preferably made of a some rubber or polymeric material which is deformable as to be mounted on a door hinge 42 (see FIG. 6). In addition, the cover 10 should be made of a material which cushions the blow when a child, person, or other object strikes a door hinge 42 so as to prevent injury or damage. When not deformed, the cover 10 is a generally cylindrically shape.

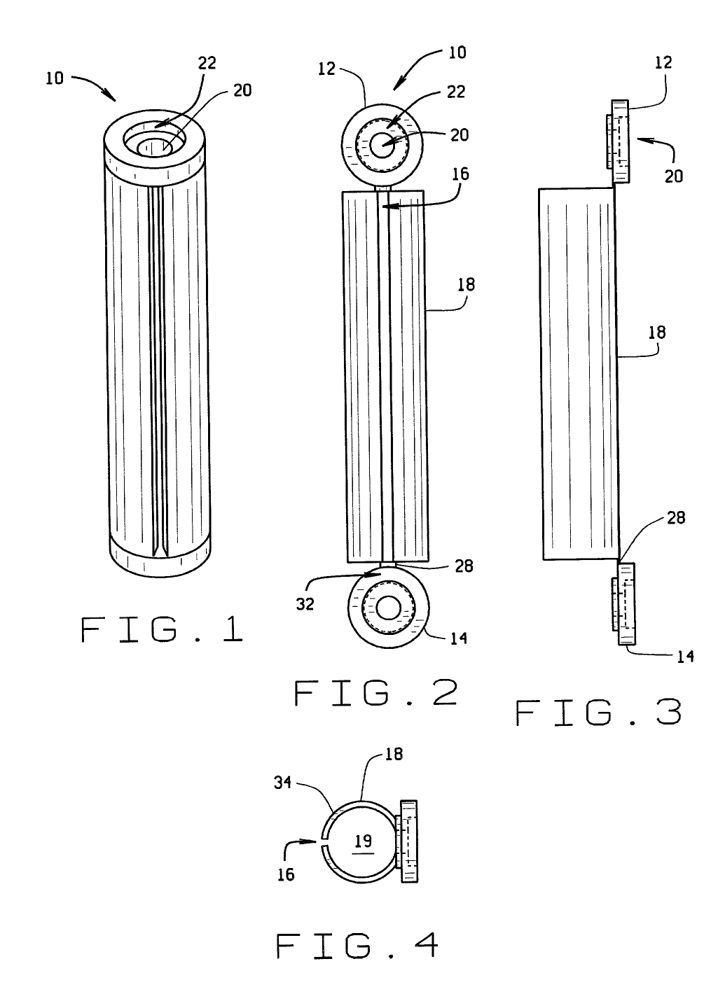

As depicted in FIG. 2, the cover 10 has a top end 12, a bottom end 14, and a vertically oriented opening 16 (see also FIG. 4) along a body portion 18. The top end 12 and bottom end 14, as depicted, may be manually deformed as to be partially pulled away from the body 18. The body forms a hollow 19, as can be seen in FIG. 4. The top end and 12 and bottom end 14 each have a central bore 20 located in the center of a cavity 22. The top end 12 and bottom end 14 are shown connected to and formed from a single piece with the body portion 18. The top end 12 and bottom end 14 are depicted for ease of illustration as being connected by a tab 28. However, it is preferred that the inner surfaces 30, 32, respectively, of the top end 12 and bottom end 14 are attached in a more substantial manner, that is, by a quarter to a half of the circumferential surface 34 (FIG. 4) of the body portion 18.

Referring now to FIG. 5, the cover 10 is shown with the mated knuckles 40 and flanges 41 of a door hinge 42 and a door hinge pin 44. The body portion 18 of the cover 10 is deformed as to be placed around the knuckles 40. The bottom end 14 of the cover 10 has an annular portion 50 which extends into the bottom 51 of the knuckles 40. Alternatively, an insert (not shown) may be substituted for the annular portion 50. As a second alternative, the bottom end 14 may be attached or formed integrally with the body portion 18 around its entire circumference surface 32. In this second alternative, the knuckles 40 would be partially slid into the body portion 18 of the cover 10 until the knuckles 40 rest against the bottom end 14. In this second alternative, the central bore 20 and cavity 22 may be eliminated from the bottom end 14. However, it is preferred that at least a portion of the bottom end 14 may separate from the door so that the opening and closing of the hinge 42 is not hindered, and the cover 10 is not unduly deformed by this.

While the cover 10 is being put over the knuckles 40, the top end 12 is lifted up. Once over the knuckles 40, the top end 12 is then allowed to rest on the top surface 52 of the knuckles 40. The door hinge pin 44 is then inserted into the central bore 20 and cavity 22 of the top end 12. It is preferred that an annular portion 54 on the top end 12 fits into the knuckles 40 a short distance along the sides of the door hinge pin 44. This annular portion 54 provides an additional frictional fit helping to prevent a child from succeeding in removing the cover 10 from the hinge 42. As depicted in FIG. 6, the head 56 of the door hinge pin 44 fits entirely within the cavity 22. Alternatively and as depicted in FIG. 7, the top end 12 may be deformed further as to cover a portion of the top of the head 56 of the door hinge pin 44.

In view of the above, it will be seen that the several objects and advantages of the present invention have been achieved and other advantageous results have been obtained. Particularly, the hinge 42 has been enveloped by the cover 10 of the present invention, and the cover 10 is secured on the hinge 42 as to resist being removed. Accordingly, protection is provided to children, people, or objects which may be injured or damaged by an accidental striking of the hinge 42.

In its simplest form, the present invention is focused on preventing a child, a person, or an object from striking any portion of the knuckles 40 of the door hinge 42. The most critical portion to protect a child from is the head 56 of the door hinge pin 44. Accordingly, the invention preferably includes the top end 12, and in one embodiment the top end 12 may be solely provided. Ideally, the top end 12 is deformed as it is installed as to cover at least a portion of the top surface of the head 56. However, the top end 12 may only cover the lateral sides, thereby providing a cushion which must be considerably deformed before an object would strike the head 56. As discussed, the top end 12 has a depending annular flange which fits within the knuckles 40 and around the door hinge pin 44.

The body portion 18 may also be provided solely in one embodiment of the present invention. In this embodiment, the body portion 18 should extend downward from the top edge of the head 56. The further downward the body portion 18 extends, the greater the protection afforded, though the body portion need not be any longer than the entire hinge 42. However, in this embodiment, a wide swinging door may cause the body portion 18 to come free. In addition, a child could simply and easily remove the body portion 18.

The opening 16 may simply be a slit in the cylindrical body portion 18. However, it is preferred that the opening 16 allows the body portion 18 to fit closely the outside surface of the knuckles 40 while accommodating the width (thickness) of the flange 41 when the door is closed. It will be appreciated that the opening 16 may be larger than what is required to accommodate only the flanges 41 so that the opening and closing of the door is accomodated.

In one embodiment, the top end 12 and bottom end 14 are identical, so that the cover 10 may be installed with either end on top or bottom of the hinge 42. As such, the variations applicable to the top end 12 are equally applicable to the bottom end 14. In addition, the bottom end 14 may omit the annular flange 50, bore 20 and cavity 22, simply being a solid piece. Also, the bottom end 14 may include a simple structure that may fit into the bottom 51 of the knuckles.

As various changes could be made in the above constructions without departing from the scope of the invention, it is intended that all matter contained in the above description or shown in the accompanying drawings shall be interpreted as illustrative and not in a limiting sense.

1. A safety cover for a door hinge including a hinge pin inserted into a hinge pin bore, said safety cover comprising:
a top end secured around the lateral sides of a head of a pin of a door hinge.

2. The safety cover of claim 1 wherein said top end has a central bore through which said hinge pin is placed in order to secure said top end.

3. The safety cover of claim 2 wherein said top end has an annular portion which fits into said hinge pin bore when said safety cover is secured.

4. The safety cover of claim 1 wherein said top end further includes a cavity into which the hinge pin fits so as to generally cover the lateral sides of said hinge pin.

5. The safety cover of claim 4 wherein said top end is secured so as to cover at least a portion of said head pin.

6. The safety cover of claim 5 wherein said top end is deformable when being secured so as to cover at least a portion of said head pin.

7. The safety cover of claim 1 wherein said door hinge includes two knuckles, said knuckles form said hinge pin bore, and said hinge pin fits into said hinge pin bore thereby joining said knuckles, said safety cover further including a body portion extending along the length of and covering at least a portion of said knuckles.

8. The safety cover of claim 7 wherein said body portion includes an opening along the length of said body portion providing for at least the width of the flanges of the knuckles.

9. The safety cover of claim 8 wherein said body portion is formed of a deformable material.

10. The safety cover of claim 1 wherein said safety cover is formed of a deformable material.

11. The safety cover of claim 7 further including a bottom end.

12. The safety cover of claim 11 wherein said bottom end is identical to said top end.

13. The safety cover of claim 11 wherein said bottom end includes a portion which is secured within said knuckles.

14. The safety cover of claim 11 wherein said bottom end includes an annular portion which is secured within said knuckles.

15. The safety cover of claim 7 wherein said top end is formed integral with said body portion.

16. The safety cover of claim 11 wherein said body portion is formed integral with said bottom portion.

17. A safety cover for a door hinge including two knuckles and a hinge pin inserted into a hinge pin bore for securing said knuckles to each other, said safety cover comprising:
a body portion extending along the length of and covering at least a portion of said knuckles, said body portion covering at least the lateral sides of said hinge pin.

18. The safety cover of claim 17 wherein said body portion includes an opening along the length of said body portion providing for at least the width of the flanges of the knuckles.

19. The safety cover of claim 17 wherein said body portion is formed of a deformable material.

20. The safety cover of claim 17 wherein said safety cover is formed of a deformable material.

21. The safety cover of claim 17 wherein said safety cover provides a covering for the length of the knuckles and hinge pin.

22. In combination with a door hinge comprising a pair of mating knuckles and a hinge pin inserted into a hinge pin bore to secure said knuckles, a safety cover comprising:
a top end secured around the lateral sides of a head of a pin of a door hinge.

23. The combination of claim 22 wherein said top end has a central bore through which said hinge pin is placed in order to secure said top end.

24. The combination of claim 23 wherein said top end has an annular portion which fits into said knuckles when said safety cover is secured.

25. The combination of claim 22 wherein said top end further includes a cavity into which the hinge pin fits so as to generally cover the lateral sides of said hinge pin.

26. The combination of claim 25 wherein said top end is secured so as to cover at least a portion of said head pin.

27. The combination of claim 26 wherein said top end is deformable when being secured so as to cover at least a portion of said head pin.

28. The combination of claim 22 wherein said door hinge includes two knuckles and said hinge pin secures said knuckles, said safety cover further including a body portion extending along the length of and covering at least a portion of said knuckles.

29. The combination of claim 28 wherein said body portion includes an opening along the length of said body portion providing for at least the width of the flanges of the knuckles.

30. The combination of claim 29 wherein said body portion is formed of a deformable material.

31. The combination of claim 22 wherein said safety cover is formed of a deformable material.

32. The combination of claim 28 further including a bottom end.

33. The combination of claim 32 wherein said bottom end is identical to said top end.

34. The combination of claim 32 wherein said bottom end includes a portion which is secured within said knuckles.

35. The combination of claim 32 wherein said bottom end includes an annular portion which is secured within said knuckles.

36. The combination of claim 28 wherein said top end is formed integral with said body portion.

37. The safety cover of claim 32 wherein said body portion is formed integral with said bottom portion.
